(19) United States
(12) Patent Application Publication
(10) Pub. No.: US 2025/0162943 A1
(43) Pub. Date: May 22, 2025

(54) CEMENTITIOUS CEMENT-BASED HYDRAULIC MATERIAL

(71) Applicants: OBAYASHI CORPORATION, Tokyo (JP); NIPPON PAPER INDUSTRIES CO., LTD., Tokyo (JP); FLOWRIC CO., LTD., Tokyo (JP)

(72) Inventors: Takayoshi HIRATA, Tokyo (JP); Akira SHIMMURA, Tokyo (JP); Hiroto TANAKA, Tokyo (JP); Yoshito NISHIMORI, Tokyo (JP); Masanobu KAWAMURA, Tokyo (JP); Makoto HIGAKI, Tokyo (JP); Minoru NEGISHI, Tokyo (JP); Hideo HOSAKA, Ibaraki (JP); Shina SADOHARA, Ibaraki (JP)

(73) Assignees: OBAYASHI CORPORATION, Tokyo (JP); NIPPON PAPER INDUSTRIES CO., LTD., Tokyo (JP); FLOWRIC CO., LTD., Tokyo (JP)

(21) Appl. No.: 18/836,514

(22) PCT Filed: Mar. 23, 2023
(86) PCT No.: PCT/JP2023/011575

§ 371 Date: Aug. 7, 2024

(30) Foreign Application Priority Data
Mar. 23, 2022 (JP) 2022-046684

(51) Int. Cl. C04B 24/24; C04B 24/26; C04B 28/04

(52) U.S. Cl. CPC C04B 24/24; C04B 24/2647; C04B 28/04

(57) ABSTRACT

A novel hydraulic material may reduce CO₂ emissions. Such a hydraulic material may contain at least lignin, a chemical admixture, cement, an aggregate, and water, a content (unit amount) of lignin being 10 kg/m³ or more and 120 kg/m³ or less, a sulfur content of lignin being 2.5% by weight or less relative to 100% by weight of lignin. Concrete and mortar may be prepared from such a hydraulic material.

### FIELD

The present invention relates to cement-based hydraulic materials, and specifically relates to a cement-based hydraulic material that can be used as a concrete material or a mortar material.

### BACKGROUND

Regarding greenhouse gases that affect global climate change, a reduction in carbon dioxide (CO₂) emission become a global common goal. In Japan, a target to reduce greenhouse gas emissions to net zero by 2050, i.e., to achieve a decarbonized society by carbon neutrality, is established. As an intermediate target, reduction of greenhouse gas emissions by 46% by 2030 compared with the emissions of the fiscal year 2013 is desired.

Sectors with high CO₂ emissions in Japan are the energy conversion sector and the industrial sector. In these sectors, thermal power plants, steel plants, cement plants, petroleum refining plants, and the like have ranked high. The total CO₂ emissions in the fiscal year 2018 in Japan equal 1.14 billion tons, while cement-related CO₂ emissions rank fourth in the industrial field in Japan, and equal 43 million tons, which correspond to about 3.8% of CO₂ emissions in Japan. It is known that cement used in construction of concrete structures emits a large amount, 600 to 800 kg/t, of CO₂ during production, and carbon neutrality in the concrete field has become a significant issue.

Patent Literature 1 describes that by controlling the chemical composition of a binding material and a unit cement amount in concrete, both a reduction in CO₂ emissions and strength development can be achieved. Patent Literature 2 describes that the absorbed amount of carbon dioxide gas is increased by adding industrial byproducts such as blast furnace slag and fly ash during carbonation aging of a concrete material and by filling the generated voids with a solidification material such as cement in order to solidify the concrete material. Patent Literature 3 describes that by using a slag fine powder as a binding material to be added to a cement composition and by using a predetermined amount of sodium carbonate as an alkali activator, the emissions of carbon dioxide in a production process can be largely reduced, and strength development can be improved to develop strength equal to or higher than that of concrete produced using cement.

On the other hand, Patent Literatures 4 and 5 describe use applications of a lignin derivative for a concrete admixture.

### CITATION LIST

### Patent Literature

### Patent Literature 1: Japanese Patent No. 5673677

### Patent Literature 2: Japanese Patent No. 5957283

### Patent Literature 3: Japanese Patent No. 5743650

Patent Literature 4: Japanese Patent Application Laid-Open No. 2011-184230 A
Patent Literature 5: Japanese Patent Application Laid-Open No. 2013-53010 A

### SUMMARY

### Technical Problem

The techniques in Patent Literatures 1 to 3 reduce, among components of concrete, the relative amount of cement that has high CO, emissions per unit during production, or the techniques absorb carbon dioxide to achieve fixation of CO₂. Patent Literatures 4 and 5 do not describe that attention is paid to the amount of CO₂ fixed, and the amount of lignin derivative added is insufficient for fixation of CO₂.

An object of the present invention is to provide a novel hydraulic material capable of reducing CO₂ emissions.

### Solution to Problem

The present invention provides the following [1] to [4].
[1] A cement-based hydraulic material comprising at least lignin, a chemical admixture, cement, an aggregate, and water, wherein
   a content (unit amount) of lignin is 10 kg/m3 or more and 120 kg/m3 or less, and a sulfur content of lignin is 2.5% by weight or less relative to 100% by weight of lignin.
[2] The material according to [1], wherein the chemical admixture comprises a component (A): a copolymer having at least two or more types of structural units selected from the group consisting of a structural unit (I) derived from a monomer represented by the following general formula (1), a structural unit (II) derived from a monomer represented by the following general formula (2), and a structural unit (III) derived from a monomer represented by the following general formula (3):

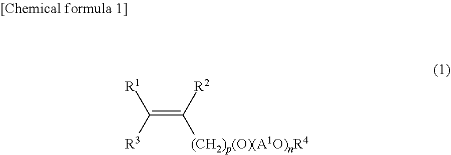

(in the general formula (1), R¹, R², and R³ each independently represent a hydrogen atom or an alkyl group of 1 to 3 carbon atoms; p represents an integer of 0 to 2; A¹Os, which may be the same as or different from each other, each represent an oxyalkylene group of 2 to 18 carbon atoms; n represents an integer of 40 to 150; and R⁴ represents a hydrogen atom or a hydrocarbon group of 1 to 30 carbon atoms);

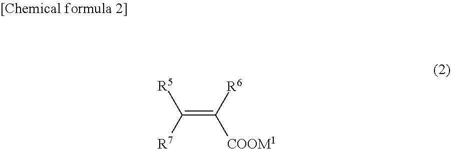

(in the general formula (2), R⁵, R⁶, and R⁷ each independently represent a hydrogen atom, —CH₃, or —(CH₂)ᵣCOOM²; when any of these is —(CH₂)ᵣCOOM², it may also form an anhydride with —COOM¹ or another —(CH₂)ᵣCOOM²; when an anhydride is formed, M¹ and M² of these groups are not present; M¹ and M², which may be the same as or different from each other, each represent a hydrogen atom, an alkali metal, an alkaline earth metal, an ammonium group, an alkylammonium group, or a substituted alkylammonium group; and r represents an integer of 0 to 2);

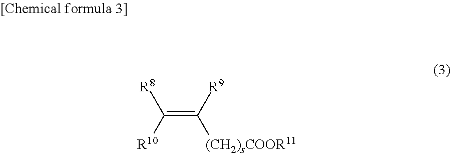

(in the general formula (3), R⁸, R⁹, and R¹⁰ each independently represent a hydrogen atom or an alkyl group of 1 to 3 carbon atoms; R¹¹ represents a hydrocarbon group of 1 to 4 carbon atoms which may contain a heteroatom; and s represents an integer of 0 to 2).
[3] Concrete prepared from the material according to [1] or [2].
[4] Mortar prepared from the material according to [1] or [2].

### Advantageous Effects of Invention

According to the present invention, a lignin component as a component containing CO₂ that has been fixed by wood via photosynthesis, is incorporated into a hydraulic material within a predetermined range. As a result, fixation of CO₂ can be achieved, and a composition, such as concrete or mortar, that has improved strength can also be provided.

### DESCRIPTION OF EMBODIMENTS

### [1. Hydraulic Material]

A hydraulic material contains at least lignin, a chemical admixture, cement, an aggregate, and water. Each component will be described below.

### [1.1 Lignin]

In the description, lignin means one (so-called industrial lignin) isolated from a lignocellulosic raw material.

### (Lignocellulosic Raw Material)

The lignocellulosic raw material is not particularly limited as long as it contains lignocellulose in its structure. Examples thereof include pulp raw materials such as woods and non-woods. Examples of woods include coniferous woods such as Japanese cedar, Ezo spruce, larch, black pine, Abies sachalinensis, Pinus parviflora, yew, Japanese arborvitae, Picea polita, Picea alcoquiana, Podocarpus macrophyllus, fir, Chamaecyparis pisifera, Pseudotsuga japonica, Thujopsis, Thujopsis dolabrata, Tsuga sieboldii, Tsuga diversifolia, Hinoki cypress, yew, Cephalotaxus harringtonia, Picea jezoensis, Chamaecyparis nootkatensis (Alaska cedar), Chamaecyparis lawsoniana (Lawson's cypress), Douglas fir (Pseudotsuga menziesii), Sitka spruce (Picea sitchensis), Pinus radiata, eastern spruce, eastern white pine, western pine, western larch, western fir, western hemlock, and tamarack; and hardwood woods such as eucalyptus, Fagus crenata, Tilia japonica, Betula platyphylla, poplar, acacia, oak, Acer pictum, Kalopanax septemlobus, elm, princess tree, Magnolia, willow, Kalopanax pictus, Quercus phillyraeoides, Quercus serrata, Quercus acutissima, Aesculus turbinata, Zelkova serrata, Betula grossa, Cornus controversa, and Fraxinus lanuginosa. The age and sampled parts of woods are not limited. Therefore, a combination of woods collected from trees having different ages, or woods collected from different parts of a tree may be used. Examples of non-woods include bamboo, kenaf, phragmites, and a rice plant. One type of lignocellulosic raw material may be solely used, and two or more types thereof may also be used in combination.

### (Sulfur Content)

The lignin preferably contains sulfur, and the sulfur content (content of sulfur atom relative to 100% by weight of the lignin) is preferably 2.5% by weight or less, and more preferably 2.1% by weight or less. The lower limit thereof may be more than 0% by weight (for example, the amount exceeding the detection limit), preferably 1.5% by weight or more, and more preferably 1.6% by weight or more. The sulfur content can be determined by ICP emission spectrochemical analysis. In Examples below, the sulfur content was determined by the same analysis.

### Specific Examples of Lignin

The structure and physical properties of lignin vary depending on a treatment method for isolation from the lignocellulosic raw material, and the lignin may be any in the following description. Examples of lignin include kraft lignin, soda lignin, soda-anthraquinone lignin, organosolv lignin, explosion lignin, sulfate lignin, and decomposed products thereof, with kraft lignin being preferable. One type of lignin may be used, and two or more types thereof may also be used in combination.

In the description, lignosulfonates are not generally contained in lignin.

### -Kraft Lignin-

Kraft lignin is also called thiolignin or sulphate lignin. Examples of kraft lignin include an alkaline solution of kraft lignin, powdered kraft lignin obtained by spray-drying an alkaline solution of kraft lignin, and an acid-precipitated kraft lignin obtained by precipitation of an alkaline solution of kraft lignin with an acid.

Examples of a method for preparing an alkaline solution of kraft lignin include a method in which an alkaline solution containing Na₂S that flows in a Kraft method pulp production process is electrolyzed by electrolytic oxidation, to produce an NaOH solution on a cathode side (Japanese Patent Application Laid-open No. 2000-336589 A). Examples of a method for preparing acid-precipitated kraft lignin, which is obtained by precipitation of an alkaline solution of kraft lignin with an acid, include a method for preparing powdered acid-precipitated kraft lignin (International Publication Nos. 2006/038863, 2006/031175, and 2012/005677).

### [1.2 Chemical Admixture]

The chemical admixture may be any admixture for concrete or mortar containing a chemical substance as an active ingredient. Examples of the chemical admixtures include a water reducing agent, a high-performance AE water reducing agent, an AE water reducing agent, a high-performance water reducing agent, a water-soluble polymer, a polymer emulsion, an air entraining agent, a cement wetting agent, a swelling agent, a waterproof agent, a retardant, a thickener, a flocculant, a drying shrinkage reducing agent, a strength enhancer, an effect enhancer, a defoaming agent, other surfactants, and chemical admixtures aimed at improving other concrete functions. Examples of the active ingredient of the chemical admixture include a polycarboxylic acid and/or a salt thereof, a compound containing a carboxyl group and/or a salt thereof (CA agent), and a compound containing a sulfonic acid group and/or a salt thereof (SA agent). Examples of the CA agent include sodium polyacrylate and sodium gluconate. Examples of the SA agent include sodium lignin sulfonate and naphthalene sulfonic acid. As the chemical admixture, one type thereof may be used, and two or more types thereof may also be used in combination.

### (Example of chemical admixture: polycarboxylic acid-based copolymer (A))

The chemical admixture preferably contains a polycarboxylic acid-based copolymer. The polycarboxylic acid-based copolymer is preferably a polycarboxylic acid-based copolymers (A) that is a copolymer having at least two or more types of structural units selected from the group consisting of structural units (I) to (III). Hereinafter, the respective structural units will be described.

### -Structural Unit (I)-

The structural unit (I) is a structural unit derived from a monomer represented by the general formula (1).

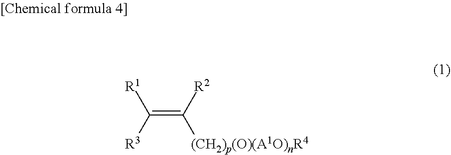

In the general formula (1), R¹, R², and R³ each independently represent a hydrogen atom or an alkyl group of 1 to 3 carbon atoms. Examples of the alkyl group of 1 to 3 carbon atoms include a methyl group, an ethyl group, an n-propyl group, and an isopropyl group. The alkyl group of 1 to 3 carbon atoms may have a substituent, and the number of carbon atoms of the substituent is not included in the number of carbon atoms of the alkyl group. R¹ is preferably a hydrogen atom. R² is preferably an alkyl group of 1 to 3 carbon atoms, more preferably a methyl group. It is presumed that, when R² is an alkyl group of 1 to 3 carbon atoms, adsorptivity to the aggregate is excellent. R³ is preferably a hydrogen atom.

In the general formula (1), p represents an integer of 0 to 2.

A¹Os in the general formula (1), which may be the same as or different from each other, each represent an oxyalkylene group of 2 to 18 carbon atoms. Examples of the oxyalkylene group (alkylene glycol unit) include an oxyethylene group (ethylene glycol unit), an oxypropylene group (propylene glycol unit), and an oxybutylene group (butylene glycol unit). An oxyethylene group and an oxypropylene group are preferable.

The above-described phrase “may be the same as or different from each other” means that when a plurality of A¹Os are contained in the general formula (1) (when n is 2 or more), A¹Os may each be the same oxyalkylene group or may be different (two or more types of) oxyalkylene groups. Examples of aspects in which a plurality of A¹Os are contained in the general formula (1) include aspects in which two or more oxyalkylene groups selected from the group consisting of an oxyethylene group, an oxypropylene group, and an oxybutylene group are mixed. An aspect in which an oxyethylene group and an oxypropylene group are mixed or an aspect in which an oxyethylene group and an oxybutylene group are mixed is preferable. An aspect in which an oxyethylene group and an oxypropylene group are mixed is more preferable. In an aspect in which different oxyalkylene groups are mixed, the addition of two or more types of oxyalkylene groups may be a block addition or a random addition.

In the general formula (1), n represents the average number of added moles of oxyalkylene groups, and represents an integer of 40 to 150. n is preferably 40 to 100, more preferably 45 to 100, still more preferably 50 to 100, and even more preferably greater than 50 and 100 or less. The average number of added moles means an average value of the number of moles of oxyalkylene groups added to one mole of a monomer.

R⁴ in the general formula (1) represents a hydrogen atom or a hydrocarbon group of 1 to 30 carbon atoms. R⁴ is preferably a hydrogen atom or a hydrocarbon group of 1 to 10 carbon atoms, more preferably a hydrogen atom or a hydrocarbon group of 1 to 5 carbon atoms, and still more preferably a hydrogen atom or a methyl group. By falling within this range, the number of carbon atoms does not become too large, and thus the dispersibility of a cement-based concrete material can be improved.

Examples of the method for producing the monomer represented by the general formula (1) include a method of adding 40 to 150 mol of alkylene oxide to an unsaturated alcohol such as allyl alcohol, methallyl alcohol, or 3-methyl-3-buten-1-ol.

Examples of the monomers that can be produced by this method include a (poly) ethylene glycol allyl ether, a (poly) ethylene glycol methallyl ether, a (poly) ethylene glycol 3-methyl-3-butenyl ether, a (poly) ethylene (poly) propylene glycol allyl ether, a (poly) ethylene (poly) propylene glycol methallyl ether, a (poly) ethylene (poly) propylene glycol 3-methyl-3-butenyl ether, a (poly) ethylene (poly) butylene glycol allyl ether, a (poly) ethylene (poly) butylene glycol methallyl ether, a (poly) ethylene (poly) butylene glycol 3-methyl-3-butenyl ether, a methoxy (poly) ethylene glycol allyl ether, a methoxy (poly) ethylene glycol methallyl ether, a methoxy (poly) ethylene glycol 3-methyl-3-butenyl ether, a methoxy (poly) ethylene (poly) propylene glycol allyl ether, a methoxy (poly) ethylene (poly) propylene glycol methallyl ether, a methoxy (poly) ethylene (poly) propylene glycol 3-methyl-3-butenyl ether, a methoxy (poly) ethylene (poly) butylene glycol allyl ether, a methoxy (poly) ethylene (poly) butylene glycol methallyl ether, and a methoxy (poly) ethylene (poly) butylene glycol 3-methyl-3-butenyl ether.

Among these, from the viewpoint of the balance of hydrophilicity and hydrophobicity, a (poly) ethylene glycol(meth)allyl ether, a (poly) ethylene (poly) propylene glycol(meth)allyl ether, a (poly) ethylene glycol 3-methyl-3-butenyl ether, and a (poly) ethylene (poly) propylene glycol 3-methyl-3-butenyl ether are preferable.

In the present specification, the expression “(poly)” means a case where a plurality of constituent elements or raw materials described thereafter are bonded or only one constituent element or raw material is present. The term “(meth)allyl” means methallyl and/or allyl, the term “(meth)acrylate” means methacrylate and/or acrylate, and the term “(meth)acrylic acid” means methacrylic acid and/or acrylic acid.

The polycarboxylic acid copolymer (A) may have only one type of structural unit (I) or may have two or more types of structural units (I) derived from monomers different from each other.

The structural unit (I) preferably includes at least a structural unit derived from a polyoxyethylene glycol monomethallyl ether represented by the following general formula (4) (hereinafter, also referred to as a “structural unit (IV)”). When the structural unit (I) includes the structural unit (IV), dispersibility may be improved. This effect is presumed to be because the chemical admixture has excellent adsorptivity to the aggregate by having the structure of the structural unit derived from a polyoxyethylene glycol monomethallyl ether represented by the following general formula (4), and can exhibit excellent dispersibility due to a certain length or more of the molecular chain.

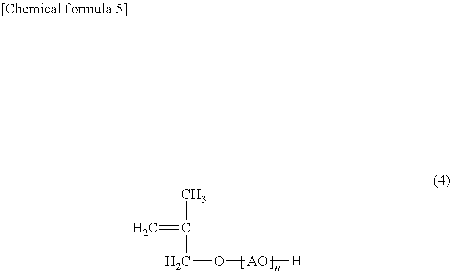

In the general formula (4), A¹Os, which may be the same as or different from each other, each represent an oxyalkylene group of 2 to 18 carbon atoms. n represents an integer of 40 to 150.

The content percentage of the structural unit (IV) in the structural unit (I) is preferably 50% by weight or more, more preferably 708 by weight or more, still more preferably 80% by weight or more, still further preferably 90% by weight or more, and particularly preferably 100% by weight.

The copolymer (A) may have only one type of structural unit (I) or may have two or more types of structural units (I) derived from monomers different from each other.

### -Structural Unit (II)-

The structural unit (II) is a structural unit derived from a monomer represented by the general formula (2).

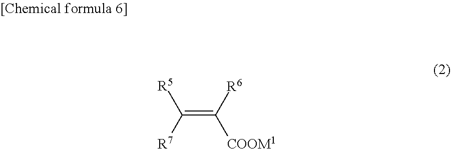

In the general formula (2), R⁵, R⁶, and R⁷ each independently represent a hydrogen atom, —CH₃, or —(CH₂)ᵣCOOM². However, when any one of them is (CH₂)ᵣCOOM², it may also form an anhydride with —COOM¹ or another —(CH₂)ᵣCOOM². When an anhydride is formed, M¹ and M² of these groups are not present. R^{b} is preferably a hydrogen atom. R⁶ is preferably a hydrogen atom or —CH₃. R⁷ is preferably a hydrogen atom.

M¹ and M², which may be the same as or different from each other, each represent a hydrogen atom, an alkali metal, an alkaline earth metal, an ammonium group, an alkylammonium group, or a substituted alkylammonium group. M¹ and M² are each preferably a hydrogen atom, an alkali metal, or an alkaline earth metal.

r represents an integer of 0 to 2, preferably 0.

Examples of the monomer represented by the general formula (2) include an unsaturated monocarboxylic acid-based monomer and an unsaturated dicarboxylic acid-based monomer. Examples of the unsaturated monocarboxylic acid-based monomer include acrylic acid, methacrylic acid, and crotonic acid; monovalent metal salts of these acids, ammonium salts of these acids, and organic amine salts of these acids. Examples of the unsaturated dicarboxylic acid include maleic acid, itaconic acid, citraconic acid, and fumaric acid; monovalent metal salts of these acids, ammonium salts of these acids, organic amine salts of these acids; and anhydrides of these. The monomer represented by the general formula (2) is preferably acrylic acid, methacrylic acid or maleic acid.

The copolymer (A) may have only one type of structural unit (II), or may have two or more types of structural units (II) derived from monomers different from each other.

### -Structural Unit (III)-

The structural unit (III) is a structural unit derived from a monomer represented by the general formula (3).

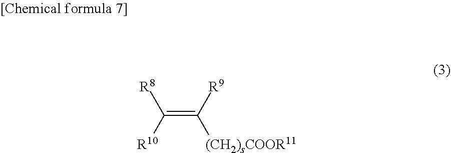

In the general formula (3), R⁸, R⁹, and R¹⁰ each independently represent a hydrogen atom or an alkyl group of 1 to 3 carbon atoms. Examples of the alkyl group of 1 to 3 carbon atoms are the same as the examples in R¹, R², and R³. R⁸ is preferably a hydrogen atom. R⁹ is preferably a hydrogen atom. R¹⁰ is preferably a hydrogen atom.

In the general formula (3), R¹¹ represents a hydrocarbon group of 1 to 4 carbon atoms which may contain a heteroatom. The number of carbon atoms in the hydrocarbon group is preferably 1 to 3, more preferably 2 to 3, and still more preferably 3. Examples of the heteroatoms include an oxygen atom, a nitrogen atom, a phosphorus atom, and a silicon atom, with an oxygen atom being preferable. Examples of the hydrocarbon group of 1 to 4 carbon atoms which may contain a heteroatom include a methyl group, an ethyl group, an n-propyl group, an isopropyl group, a butyl group, an isobutyl group, a sec-butyl group, a 2-hydroxyethyl group, a 2-hydroxypropyl group, a 4-hydroxybutyl group, and a glycelyl group. R¹¹ may contain one heteroatom or two or more heteroatoms. When two or more heteroatoms are contained, the respective heteroatoms may be the same as or different from each other.

R¹¹ is preferably a hydrocarbon group of 1 to 4 carbon atoms containing a heteroatom, and more preferably a hydrocarbon group of 1 to 4 carbon atoms containing an oxygen atom. Examples of the group include a 2-hydroxyethyl group, a 2-hydroxypropyl group, a 4-hydroxybutyl group, and a glyceryl group, with a 2-hydroxypropyl group being preferred.

In the general formula (3), s represents an integer of 0 to 2, preferably 0.

Examples of the monomer represented by the general formula (3) include monoester forms of unsaturated monocarboxylic acids. Examples of the monoesters of unsaturated monocarboxylic acids include methyl(meth)acrylate , ethyl (meth)acrylate, 2-hydroxyethyl (meth)acrylate, 2-hydroxypropyl(meth)acrylate, 4-hydroxybutyl(meth)acrylate, and glyceryl(meth)acrylate.

The copolymer (A) may have only one type of structural unit (III), or may have two or more types of structural units (III) derived from monomers different from each other.

### -Structural Unit (V)-

The copolymer (A) may have a structural unit (V) separately from the structural units (I) to (III). The structural unit (V) is a structural unit derived from a monomer that is copolymerizable with the monomers represented by the general formulas (1) to (3). The monomer that is copolymerizable with the monomers represented by the general formulas (1) to (3) is structurally distinguished from the monomers represented by the general formulas (1) to (3). Examples of the monomer constituting the component unit (V) include, but not particularly limited to, respective monomers described below, and only one type of these monomers may be solely used or two or more types thereof may be used in combination.

3 and 3′-Allyl-substituted products of diallylbisphenols (for example, 4,4′-dihydroxydiphenylpropane, 4,4′-dihydroxydiphenylmethane, and 4, 4′-dihydroxydiphenylsulfone) represented by the following general formula (V-1);

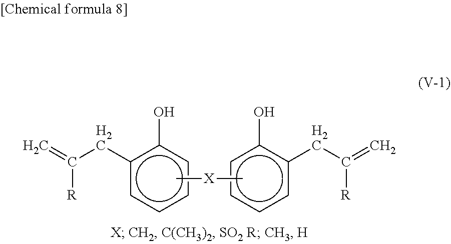

3-Allyl substituted products of monoallylbisphenols (for example, 4,4′-dihydroxydiphenylpropane, 4,4′-dihydroxydiphenylmethane, and 4, 4′-dihydroxydiphenylsulfone) represented by the general formula (V-2);

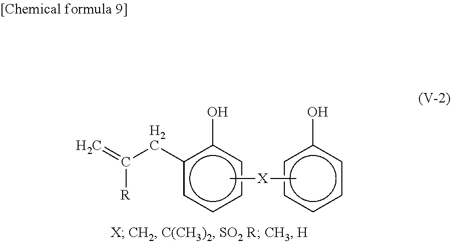

Allylphenol represented by the following general formula (V-3);

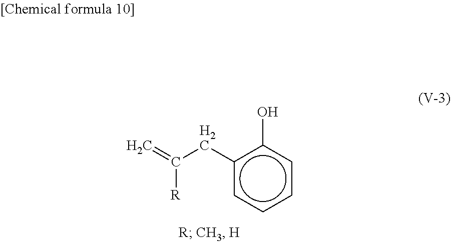

Products obtained by esterifying an unsaturated monocarboxylic acid, such as acrylate or methacrylate, with a (poly) alkylene glycol such as (poly) ethylene glycol, (poly) ethylene (poly) propylene glycol, (poly) ethylene (poly) butylene glycol, methoxy (poly) ethylene glycol, methoxy (poly) ethylene (poly) propylene glycol, or methoxy (poly) ethylene (poly) butylene glycol: for example, (poly) alkylene glycol(meth)acrylate such as (poly) ethylene glycol(meth)acrylate, (poly) ethylene (poly) propylene glycol(meth)acrylate, (poly) ethylene (poly) butylene glycol(meth)acrylate , methoxy (poly) ethylene glycol(meth)acrylate , methoxy (poly) ethylene (poly) propylene glycol(meth)acrylate, and methoxy (poly) ethylene (poly) butylene glycol(meth)acrylate;

Half esters and diesters of unsaturated dicarboxylic acids such as maleic acid, maleic anhydride, fumaric acid, itaconic acid, and citraconic acid and alcohols of 1 to 30 carbon atoms; half amides and diamides of the unsaturated dicarboxylic acids and amines of 1 to 30 carbon atoms;

Half esters and diesters of alkyl (poly) alkylene glycols obtained by adding 1 to 500 moles of an alkylene oxide of 2 to 18 carbon atoms to the above-mentioned alcohol or amine and the above-mentioned unsaturated dicarboxylic acids;

Half esters and diesters of the above-mentioned unsaturated dicarboxylic acids with glycols of 2 to 18 carbon atoms or polyalkylene glycols of these glycols of which the addition molar number is 2 to 500;

Half amides of maleamic acid with glycols of 2 to 18 carbon atoms or polyalkylene glycols of these glycols of which the addition molar number is 2 to 500;

Esters of alkoxy (poly) alkylene glycols and unsaturated monocarboxylic acids such as (meth)acrylic acid, the alkoxy (poly) alkylene glycols being obtained by adding 1 to 500 moles of an alkylene oxide of 2 to 18 carbon atoms to an alcohol of 1 to 30 carbon atoms;

Addition products of alkylene oxides of 2 to 18 carbon atoms (of which the addition molar number is 1 to 500) and unsaturated monocarboxylic acids such as (meth)acrylic acid, such as (poly) ethylene glycol monomethacrylate, (poly) propylene glycol monomethacrylate, (poly) butylene glycol monomethacrylate, and the like (excluding monomers represented by the general formulas (1) to (3));

(Poly) alkylene glycol di(meth)acrylates such as triethylene glycol di (meta) acrylate, (poly) ethylene glycol di (meta) acrylate, polypropylene glycol di (meta) acrylate, and (poly) ethylene glycol (poly) propylene glycol di(meth)acrylate;

Polyfunctional(meth)acrylates such as hexanediol di(meth)acrylate, trimethylolpropane tri(meth)acrylate, and trimethylolpropane di(meth)acrylate;

(Poly) alkylene glycol dimaleates such as triethylene glycol dimaleate and polyethylene glycol dimaleate;

Unsaturated sulfonic acids such as vinyl sulfonate, (meth)allyl sulfonate, 2-(meth)acryloxyethyl sulfonate, 3-(meth)acryloxypropyl sulfonate, 3-(meth)acryloxy-2-hydroxypropyl sulfonate, 3-(meth)acryloxy-2-hydroxypropyl sulfophenyl ether, 3-(meth)acryloxy-2-hydroxypropyloxy sulfobenzoate, 4-(meth)acryloxybutyl sulfonate, (meth)acrylamidomethyl sulfonic acid, (meth)acrylamidoethyl sulfonic acid, 2-methylpropanesulfonic acid(meth)acrylamide, and styrene sulfonic acid, and monovalent metal salts thereof, divalent metal salts thereof, ammonium salts thereof and organic amine salts thereof;

Amides of unsaturated monocarboxylic acids such as methyl(meth)acrylamide and amines of 1 to 30 carbon atoms;

Vinyl aromatics such as styrene, α-methylstyrene, vinyltoluene, and p-methylstyrene;

Alkanediol mono(meth)acrylates such as 1,5-pentanediol mono(meth)acrylate and 1, 6-hexanediol mono(meth)acrylate (excluding the monomers represented by the general formula (3));

Dienes such as butadiene, isoprene, 2-methyl-1, 3-butadiene, and 2-chloro-1, 3-butadiene;

Unsaturated amides such as (meth)acrylamide, (meth) acrylalkylamide, N-methylol(meth)acrylamide, and N, N-dimethyl(meth)acrylamide; Unsaturated cyanides such as (meth)acrylonitrile and α-chloroacrylonitrile;

Unsaturated esters such as vinyl acetate and vinyl propionate;

Unsaturated amines such as aminoethyl(meth)acrylate , methylaminoethyl(meth)acrylate, dimethylaminoethyl(meth)acrylate, dimethylaminopropyl(meth)acrylate , dibutylaminoethyl(meth)acrylate, and vinylpyridine (excluding the monomers represented by the general formula (3));

Divinylaromatics such as divinylbenzene; Cyanurates such as triallyl cyanurate;

Allyls such as (meth)allyl alcohol and glycidyl(meth)allyl ether; Vinyl ethers or allyl ethers such as a methoxypolyethylene glycol monovinyl ether, a polyethylene glycol monovinyl ether, a methoxypolyethylene glycol mono(meth)allyl ether, and a polyethylene glycol mono(meth)allyl ether (excluding the monomers represented by the general formula (1)); and

Siloxane derivatives such as polydimethylsiloxane propylamino maleamic acid, polydimethylsiloxane aminopropylele maleamic acid, polydimethylsiloxane-bis-(propylamino maleamic acid), polydimethylsiloxane-bis-(dipropyleneamino maleamic acid), polydimethylsiloxane-(1-propyl-3-acrylate), polydimethylsiloxane-(1-propyl-3-methacrylate), polydimethylsiloxane-bis-(1-propyl-3-acrylate), and polydimethylsiloxane-bis-(1-propyl-3-methacrylate) (excluding the monomers represented by the general formula (3)).

The copolymer (A) may have only one type of structural unit (V) or may have two or more types of structural units (V) derived from monomers different from each other.

### (Preferable Examples of Copolymer (A): Copolymer (A-1) to (A-4))

Hereinafter, configuration examples of the copolymer (A) will be described. In the following copolymers (A-1) to (A-4), one type of the respective structural units (I) to (V) may be contained, or two or more types thereof may be contained in combination.

### -Copolymer (A-1)-

The copolymer (A-1) has the structural unit (I) and the structural unit (II). The content ratio of the respective structural units, i.e., the structural unit (I)/the structural unit (II) is preferably 1 to 99% by weight/1 to 99% by weight, more preferably 10 to 98% by weight/2 to 90% by weight, and still more preferably 50 to 98% by weight/2 to 50% by weight.

### -Copolymer (A-2)-

The copolymer (A-2) has the structural unit (I) and the structural unit (III). The content ratio of the respective structural units, i.e., the structural unit (I)/the structural unit (III) is preferably 1 to 99% by weight/1 to 99% by weight, more preferably 10 to 90% by weight/10 to 90% by weight, and still more preferably 10 to 80% by weight/20 to 90% by weight.

### -Copolymer (A-3)-

The copolymer (A-3) has the structural unit (II) and the structural unit (III). The content ratio of the respective structural units, i.e., the structural unit (II)/the structural unit (III) is preferably 1 to 99% by weight/1 to 99% by weight, more preferably 1 to 90% by weight/10 to 99% by weight, and still more preferably 1 to 80% by weight/20 to 99% by weight.

### -Copolymer (A-4)-

The copolymer (A-4) has the structural unit (I), the structural unit (II), and the structural unit (III). The content ratio of the respective structural units, i.e., the structural unit (I)/the structural unit (II)/the structural unit (III) is preferably 1 to 98% by weight/1 to 98% by weight/1 to 98% by weight, more preferably 10 to 89% by weight/1 to 80% by weight/10 to 89% by weight, and still more preferably 15 to 79% by weight/1 to 75% by weight/20 to 848 by weight.

Among the above-mentioned copolymers, the copolymers containing at least the structural unit (I), that is, the copolymers (A-1), (A-3), and (A-4) are preferable, the copolymer (A-1) or (A-4) is more preferable, and the copolymer (A-1) is still more preferable.

### -Method for Producing Copolymer-

The copolymer (A) can be produced by copolymerizing the respective predetermined monomers by a publicly known method. Examples of the method include polymerization methods such as polymerization in a solvent and bulk polymerization.

### (Reaction Solvent)

Examples of solvents used in polymerization in a solvent include water; a lower alcohol such as methyl alcohol, ethyl alcohol, and isopropyl alcohol; an aromatic hydrocarbon such as benzene, toluene, and xylene; an aliphatic hydrocarbon such as cyclohexane and n-hexane; esters such as ethyl acetate; and ketones such as acetone and methyl ethyl ketone. From the viewpoint of solubility of the raw material monomers and resulting copolymers, it is preferable to use at least any of water and a lower alcohol, and it is more preferable to use water.

When copolymerization is performed in a solvent, the respective monomers and a polymerization initiator may each be continuously added dropwise to a reaction vessel, or a mixture of the respective monomers and a polymerization initiator may each be continuously added dropwise to a reaction vessel. Furthermore, a solvent may be charged in a reaction vessel, and the mixture of the monomers and the solvent and a polymerization initiator solution may each be continuously added dropwise into the reaction vessel, or a part or the entirety of the monomers may be charged in a reaction vessel, and a polymerization initiator may be continuously added dropwise.

### (Initiator)

The polymerization initiator that can be used for copolymerization is not particularly limited. Examples of the polymerization initiator that can be used in copolymerization in an aqueous solvent include a persulfate such as ammonium persulfate, sodium persulfate, and potassium persulfate; and a water-soluble peroxide such as t-butyl hydroperoxide and hydrogen peroxide. In this case, an accelerator such as L-ascorbic acid, sodium bisulfite, or Mohr's salt may be used in combination.

Examples of the polymerization initiator that can be used in copolymerization in a solvent such as a lower alcohol, an aromatic hydrocarbon, an aliphatic hydrocarbon, esters, or ketones include a peroxide such as benzoyl peroxide and lauryl peroxide; a hydroperoxide such as cumene peroxide; and an aromatic azo compound such as azobisisobutyronitrile. In this case, an accelerator such as an amine compound may be used in combination.

The polymerization initiator that can be used copolymerization in a water-lower alcohol mixed solvent may be appropriately selected from the above-mentioned polymerization initiators or combinations of polymerization initiators and accelerators.

The polymerization temperature is appropriately different depending on the polymerization conditions such as the solvent used and the type of the polymerization initiator, and is usually 50 to 120° C.

### -Chain Transfer Agent-

In copolymerization, the molecular weight can be adjusted by using a chain transfer agent as necessary. Examples of the chain transfer agent that can be used include known thiol compounds such as mercaptoethanol, thioglycerol, thioglycolic acid, 2-mercaptopropionic acid, 3-mercaptopropionic acid, thiomalic acid, octyl thioglycolate, and 2-mercaptoethanesulfonic acid; and lower oxides and their salts thereof such as phosphorous acid, hypophosphorous acid, and their salts (sodium hypophosphite, potassium hypophosphite, etc.), sulfurous acid, hydrogen sulfite, dithionous acid, metabisulfite, and their salts (sodium sulfite, potassium sulfite, sodium hydrogen sulfite, potassium hydrogen sulfite, sodium dithionite, potassium dithionite, sodium metabislfite, potassium metabisulfite, etc.). As these agents, one type thereof may be solely used, and two or more types thereof may be used in combination.

In order to adjust the molecular weight of the copolymer, the monomer (VI) that is other than the monomer represented by the general formulas (1) to (3) and the monomer constituting the structural unit (V) and that has high chain transfer ability may be used. Examples of the monomer (VI) having high chain transfer ability include a (meth)allyl sulfonic acid-based (salt) monomer. The blending percentage of the monomer (VI) in the copolymer is usually 20% by weight or less, preferably 10% by weight or less. The above-mentioned blending percentage is a blending percentage relative to 100% by weight of the total of the blending percentage of the monomer represented by the general formula (1), the blending percentage derived from the monomer represented by the general formula (2), the blending percentage of the monomer represented by the general formula (3), and the blending percentage of the monomer constituting the structural unit (V) in the production of the copolymer.

### -Neutralization-

When the copolymer is obtained by performing copolymerization in an aqueous solvent, pH at the time of polymerization usually becomes strongly acidic due to the effect of the monomers having an unsaturated bond, and the pH may be adjusted to an appropriate pH. When pH needs to be adjusted during the polymerization, pH may be adjusted using an acidic substance such as phosphoric acid, sulfuric acid, nitric acid, alkyl phosphoric acid, alkyl sulfate, alkyl sulfonic acid, or (alkyl) benzenesulfonic acid. Among these acidic substances, phosphoric acid is preferable from the viewpoint of pH buffering action and the like.

The polymerization reaction is preferably performed at pH of 2 to 7 in order to eliminate instability of the ester bond of the ester-based monomer. Although there is no particular limitation on the alkaline substance that can be used for adjusting pH, an alkaline substance such as NaOH, Ca(OH), or the like is generally used. The monomers prior to polymerization or the copolymer solution after polymerization may be subjected to pH adjustment. Furthermore, after part of the alkaline substance is added prior to polymerization and polymerization is subsequently performed, further pH adjustment may be performed on the copolymer.

### -Weight-Average Molecular Weight-

The weight-average molecular weight of the copolymer (A) is preferably 5,000 or more, more preferably 6,000 or more, and even more preferably 6, 500 or more. As a result, the dispersibility of the hydraulic material is sufficiently exhibited, and the water-reducing ratio exceeding those of AE water reducing agents such as a lignin sulfonic acid-type reducing agent or a oxycarboxylic acid-type reducing agent can be obtained, and the fluidity or the workability can be improved. The upper limit of the weight-average molecular weight is preferably 60,000 or less, more preferably 50,000 or less, and even more preferably 30,000 or less. As a result, the agglomeration action of the particles in the hydraulic material is suppressed, and the workability can be improved. The weight-average molecular weight is preferably 5,000 to 60,000, more preferably 6,000 to 50,000, and even more preferably 6,500 to 30,000.

The molecular weight distribution (Mw/Mn) of the copolymer is preferably 1.0 or more, and more preferably 1.2 or more. The upper limit is preferably 3.0 or less, and more preferably 2.5 or less. The molecular weight distribution is preferably in the range of 1.0 to 3.0, more preferably 1.2 to 2.5.

The weight-average molecular weight may be measured by a publicly known method as a polyethylene glycol-equivalent value by gel permeation chromatography (GPC).

GPC measuring conditions include the following condition. The weight-average molecular weight in the examples below is a value measured under this condition. Measuring apparatus; manufactured by Tosoh Corporation Columns used; Shodex Column OH-pak SB-806HQ, SB-804HQ, B-802.5HQ
Eluent; 0.05 mM sodium nitrate/acetonitrile 8/2 (v/v)
Standard substance; polyethylene glycol (manufactured by
Tosoh Corporation, GL Sciences Inc.)
Detector; Differential refractometer (manufactured by Tosoh Corporation)
Calibration curve; polyethylene glycol standard

The chemical admixture may contain one type or two or more types of polycarboxylic acid-based copolymers and preferably contains the copolymer (A) or the copolymer (A) and other polycarboxylic acid-based copolymers.

### [1.3 Cement]

Examples of cement include portland cement (for example, normal, early strength, ultra early strength, moderate heat, and sulfate resistant portland cements, and low alkaline forms thereof), various types of mixed cement (for example, blast furnace cement, silica cement, and fly ash cement), white portland cement, alumina cement, ultra rapid hardening cement (for example, one-clinker rapid hardening cement, two-clinker rapid hardening cement, and magnesium phosphate cement), cement for grout, oil well cement, low-exothermic cement (for example, low-exothermic blast furnace cement, fly ash mixing low-exothermic blast furnace cement, and high-content belite cement), ultra-high strength cement, cement-based solidification material, ecocement (for example, cement produced from one or more types of ash from incinerated general municipal wastes and sewage sludge incineration ash as a raw material), and other publicly known cement. To the cement, a component other than cement, such as blast furnace slag, fly ash, cinder ash, clinker ash, husk ash, silica fume, fine powder such as silica powder or limestone powder, or gypsum may be added.

### [1.4 Aggregate]

An aggregate may be generally a combination of a fine aggregate and a coarse aggregate.

### -Fine Aggregate-

Examples of a fine aggregate may include sand, gravel, and crushed stone; water granulated slag; recycled aggregates; and aggregates having a relatively small particle diameter, such as silica aggregates, clayey soil aggregates, zircon aggregates, high alumina aggregates, silicon carbide aggregates, graphite aggregates, chromium aggregates, chrome magnesite aggregates, and magnesia aggregates.

### -Coarse Aggregate-

Examples of a coarse aggregate may include sand, gravel, and crushed stone; water granulated slag; recycled aggregates; fire-resistant aggregates such as silica fire-resistant aggregates, clayey soil fire-resistant aggregates, zircon fire-resistant aggregates, high alumina fire-resistant aggregates, silicon carbide fire-resistant aggregates, graphite fire-resistant aggregates, chromium fire-resistant aggregates, chrome magnesite fire-resistant aggregates, and magnesia fire-resistant aggregates.

### [1.5 Water]

Examples of water may include tap water, water other than tap water (river water, lake water, well water, groundwater, industrial water, etc.), and recovered water (supernatant water and sludge water).

### [1.6 Content of Each Component]

The cement-based hydraulic material needs to contain the components described above. The contents thereof are not particularly limited, and examples thereof are as follows.

### (Content of Lignin)

The content (unit amount) of lignin is generally 10 kg/m3 or more, and preferably 30 kg/m3 or more. In this case, a sufficient amount of fixed CO₂ can be achieved. The upper limit of the content is an amount corresponding to generally 120 kg/m3 or less, and preferably 110 kg/m3 or less. In this case, the strength of concrete and mortar can be sufficiently enhanced. The unit amount as used herein is the weight per 1 m³ of a cured product (for example, concrete or mortar) of the material.

### (Content of Chemical Admixture)

The content of the chemical admixture relative to the cement is generally 0.1% by weight or more, preferably 0.2% by weight or more, and more preferably 0.3% by weight or more. The upper limit thereof is generally 0.8% by weight or less, preferably 0.7% by weight or less, and more preferably 0.5% by weight or less. When the chemical admixture contains the polycarboxylic acid-based copolymer (A) that is the preferred example, the content of the 30 Docket No. PNPA-240609-US, AU, TH, ID: FINAL copolymer (A) relative to the cement is generally 0.01% by weight or more, and preferably 0.05% by weight or more. The upper limit thereof is generally 0.7% by weight or less, and preferably 0.5% by weight or less.

### (Content of Cement)

The content (unit amount) of the cement is an amount corresponding to generally 100 kg/m³ or more, preferably 150 kg/m³ or more, and more preferably 200 kg/m³ or more. The upper limit thereof is generally 500 kg/m³ or less, preferably 450 kg/m³ or less, and more preferably 400 kg/m³ or less.

### (Content of Aggregate)

The aggregate is generally classified as a fine aggregate or a coarse aggregate. At least one of these aggregates needs to be contained. In general, in a case of concrete, a fine aggregate and a coarse aggregate are used in combination, and in a case of mortar, a fine aggregate is used.

When a fine aggregate is contained, the content (unit amount) of the fine aggregate is generally 400 kg/m³ or more, preferably 450 kg/m³ or more, and more preferably 500 kg/m³ or more. The upper limit thereof is generally 1,500 kg/m³ or less, preferably 1, 300 kg/m³ or less, and more preferably 1, 200 kg/m³ or less. In a case of a material for concrete, the upper limit thereof is generally 800 kg/m³ or less, preferably 750 kg/m³ or less, and more preferably 700 kg/m³ or less.

When a coarse aggregate is contained, the content (unit amount) of the coarse aggregate (for example, a material for concrete) is an amount corresponding to generally 800 kg or more, preferably 850 kg/m³ or more, and more preferably 900 kg/m³ or more. The upper limit thereof is generally 1,200 kg/m³ or less, preferably 1, 150 kg/m³ or less, and more preferably 1, 100 kg/m³ or less.

The content of the aggregate (the content (unit amount) of the sum of the fine aggregate and the coarse aggregate) is generally 1,000 kg/m³ or more, preferably 1,100 kg/m³ or more, and more preferably 1,200 kg/m³ or more. The upper limit thereof is generally 2,000 kg/m³ or less, preferably 1, 900 kg/m³ or less, and more preferably 1,800 kg/m³ or less.

### (Content of Water)

The content (unit amount) of water is generally 100 kg/m³ or more, preferably 120 kg/m³ or more, and more preferably 150 kg/m³ or more. The upper limit thereof is an amount corresponding to generally 250 kg/m³ or less, preferably 240 kg/m³ or less, and more preferably 230 kg/m³ or less. The ratio of water to cement (water/cement) is generally 40% or more, and preferably 42% or more. The upper limit thereof is generally 60% or less, and preferably 55% or less.

### [1.7 Optional Component]

The cement-based hydraulic material may contain an optional component in addition to the aforementioned components. Examples of an optional material may include so-called admixtures (excluding a chemical admixture) such as fly ash, cinder ash, clinker ash, husk ash, silica fume, silica powder, volcanic ash, fuller's earth, blast furnace slag powder, expansive additive, silicate fine powder, and limestone fine powder. They may be previously contained in cement, or be contained by adding separately from cement. In addition, examples thereof may include a hydraulic material other than cement, such as gypsum (hemihydrate gypsum, dihydrate gypsum, etc.), and dolomite.

### [1.8 Use Application of Cement-Based Hydraulic Material]

The cement-based hydraulic material may be used, for example, as a material for concrete, mortar, or grout when it is cured. In particular, the cement-based hydraulic material is useful as a material for concrete or mortar. Examples of concrete may include concrete such as ready-mixed concrete, concrete for a concrete secondary product (precast concrete), concrete for centrifugal casting, concrete for vibrocompaction, steam hardening concrete, and spraying concrete. Furthermore, the cement-based hydraulic material is useful as concrete requiring high flowability, such as medium fluidity concrete (concrete having a slump of 22 to 25 cm), high fluidity concrete (concrete having a slump of 25 cm or more and a slump flow of 50 to 70 cm), anti-washout underwater concrete, self-compacting concrete, and self-leveling material.

### [2. Methods for Producing Concrete and Mortar]

Concrete can be produced by mixing the respective components of the cement-based hydraulic material (with kneading). An example of mixing order may be an aspect in which the components other than water and the chemical admixture are added and mixed all at once or sequentially, and water and the chemical admixture are added and mixed. When mixing, a publicly known mixer can be used. By hardening the mixture in a desired frame after the mixing, concrete, mortar, or grout can be obtained, and thus a desired structure can be produced.

### EXAMPLES

Hereinafter, the present invention will be described using Examples. The present invention is not limited to Examples described below.

### Production Example 1<Separation of Lignin>

By a publicly known method, kraft lignin was separated. Specifically, a coniferous (N material) kraft digestion black liquor was aerated with carbon dioxide to reduce the pH of the black liquor to 10, and primary filtration was performed. The residue of primary filtration was dispersed in water again, the pH was reduced to 2 using sulfuric acid, and secondary filtration was performed, followed by water-washing and drying, to obtain N material kraft lignin (KL1). The sulfur content of the obtained N material kraft lignin was 2.0% by weight. From the carbon content (65%) of the N material kraft lignin, the amount of fixed carbon dioxide per kilogram of the N material kraft lignin was calculated to be 2.4 kg.

### Production Example 2<Separation of Lignin>

By a publicly known method, kraft lignin was separated. Specifically, a hardwood (L material) kraft digestion black liquor was aerated with carbon dioxide to reduce the pH of the black liquor to 10, and primary filtration was performed. The residue of primary filtration was dispersed in water again, the pH was reduced to 2 using sulfuric acid, and secondary filtration was performed, followed by water-washing and drying, to obtain L material kraft lignin (KL2). The sulfur content of the obtained L material kraft lignin was 2.2% by weight. From the carbon content (63%) of the L material kraft lignin, the amount of fixed carbon dioxide per kilogram of the L material kraft lignin was calculated to be 2.3 kg.

### Production Example 3<Preparation of Chemical Admixture>

In a glass reaction vessel equipped with a thermometer, a stirrer, a reflux condenser, a nitrogen inlet tube, and a dropping device, 733 parts of water was charged, and inside air of the reaction vessel was replaced with nitrogen gas while stirring. Water was heated to 80° C. in a nitrogen atmosphere. Subsequently, a monomer aqueous solution obtained by mixing 25 parts of methacrylic acid, 20 parts of acrylic acid, 95 parts of methoxy polyethylene glycol methacrylate (average addition molar number of ethylene oxide: 25) and 65 parts of water, and a mixed liquid containing 3 parts of ammonium persulfate and 87 parts of water were each continuously added dropwise to the reaction vessel, which was held at 80° C., for 2 hours. The temperature was further held at 100° C., and a reaction was performed for 1 hour to obtain an aqueous solution of a copolymer. The content of the copolymer of the monomer including acrylic acid and/or acrylate salt and the monomer including methacrylic acid and/or methacrylate salt in the above-mentioned copolymer was 2% by weight, and the pH of this aqueous solution was adjusted to 7 using a 30% NaOH aqueous solution. The weight-average molecular weight of the copolymer (AD1) in the solution was 19,000, and Mw/Mn was 1.4.

### Production Example 4<Preparation of Chemical Admixture>

In a glass reaction vessel equipped with a thermometer, a stirrer, a reflux condenser, a nitrogen inlet tube, and a dropping device, 2733 parts of water and 600 parts of an ethylene oxide adduct of methallyl alcohol (average addition molar number of ethylene oxide: 57) were charged, and inside air of the reaction vessel was replaced with nitrogen gas while stirring. The mixture was heated to 40° C. in a nitrogen atmosphere. Subsequently, a monomer aqueous solution obtained by mixing 126 parts of acrylic acid, 6 parts of 3-mercaptopropionic acid, and 654 parts of water, a mixed liquid containing 2 parts of hydrogen peroxide and 244 parts of water, and a mixed liquid of 5 parts of L-ascorbic acid and 245 parts of water were each 35 Docket No. PNPA-240609-US, AU, TH, ID: FINAL continuously added dropwise to the reaction vessel, which was held at 40° C., for 2 hours. After the dropwise addition was completed, the temperature was further held at the same temperature, and a reaction was performed for 1 hour to obtain an aqueous solution of a copolymer. The weight-average molecular weight of the copolymer (AD2) in the solution was 22,000, and Mw/Mn was 1.60.

### Examples 1 to 4 and Comparative Examples 1 to 2

### <Blend of Concrete>

Using materials listed in Table 1 and the concrete blend listed in Table 2, a concrete test was performed. In Examples 1 to 4, the kraft lignin (KL1 or KL2) obtained in Production Example 1 or 2 was added in each amount shown in Table 2. In Comparative Example 2, VANILLEX N (manufactured by Nippon Paper Industries Co., Ltd., sodium ligninsulfonate, sulfur content: 5.0% by weight, SP50) was added instead of kraft lignin in an amount shown in Table 2. In Examples 1 to 3 and Comparative Examples 1 and 2, the chemical admixture (AD1) obtained in Production Example 3 was added in each amount shown in Table 3. In Example 4, the chemical admixture (AD2) obtained in Production Example 4 was added in an amount shown in Table 3 instead of AD1.

TABLE 1
Materials used

| Type | Mark | Type and production area |
|---|---|---|
| Cement | C | Mixture of equal amounts of 3 types of ordinary |
| | | portalnd cement available from TAIHEIYO |
| | | CEMENT CORPORATION, UBE-MITSUBISHI |
| | | CEMENT CORPORATION, and SUMITOMO |
| | | OSAKA CEMENT, Co., Ltd. Density 3.16 g/cm³ |
| Fine aggregate | S | Mountain sand from Kakegawa Density |
| | | 2.57 g/cm³ |
| Coarse | G | Crushed stone 2005: Ome crushed stone Density |
| aggregate | | 2.65 g/cm³ |
| Water | W | Tap water from Tsukuba-city |
| Chemical | AD1 | Production Example 3 |
| admixture | AD2 | Production Example 4 |

TABLE 2
Concrete blend

| | W/C | Chemical | Unit amount (kg/m³) | | | | | |
|---|---|---|---|---|---|---|---|---|
| No. | (%) | admixture | W | C | S | G | Type of lignin | Lignin content * |
| Example 1 | 45.0 | AD1 | 165 | 367 | 640 | 1036 | KL1 | 50 |
| Example 2 | 45.0 | AD1 | 165 | 367 | 595 | 1036 | KL2 | 75 |
| Example 3 | 45.0 | AD1 | 165 | 367 | 550 | 1036 | KL1 | 100 |
| Example 4 | 45.0 | AD2 | 165 | 367 | 550 | 1036 | KL1 | 100 |
| Comparative Example 1 | 45.0 | AD1 | 165 | 367 | 460 | 1036 | KL1 | 150 |
| Comparative Example 2 | 45.0 | AD1 | 165 | 367 | 640 | 1036 | SP | 50 |

[Bottom notes in Table 2]
* Lignin content: weight (unit: kg) per 1 m³ of concrete

### <Method for Kneading Concrete>

In the kneading of concrete, a forced biaxial mixer with a nominal volume of 55 L manufactured by Pacific Machinery & Engineering Co., Ltd., was used.

A concrete kneading procedure is as follows.

Gravel (coarse aggregate), a half amount of sand (fine aggregate), kraft lignin, cement, and a half amount of sand (fine aggregate) were added and then kneaded for 10 seconds. Subsequently, water and the chemical admixture were added and then kneaded for 120 seconds. Lastly, the mixture was discharged from the mixer.

### <Test Items>

The composition (concrete) discharged from the mixer was subjected to the following tests.

### -Freshness Properties Test-

In a freshness properties test, the slump, air content, and temperature of the mixture were measured. Methods for measuring the slump and the air content are in accordance with JIS A1101 and JIS A1128, respectively. The slump and the air content were adjusted within the following ranges of target values by the addition rate of the admixture.

### Target Values

Slump: 12.5+2.5 cm
Air content: 4.5+1.5%

### -Compressive Strength Test-

In a compressive strength test, a specimen having a diameter of 10 cm and a length of 20 cm was produced and aged in water, and the compressive strength of the specimen was measured in accordance with JIS A1108.

The test results are shown in Table 3.

TABLE 3
Test results

| | | | | Compressive | Compressive |
|---|---|---|---|---|---|
| | Admixture | | Air | strength at | strength at |
| | addition | Slump | content | age of 7 days | age of 28 days |
| | rate (%)** | (cm) | (%) | (N/mm²) | (N/mm²) |
| Example 1 | 0.36 | 13.1 | 5.2 | 16.3 | 19.1 |
| Example 2 | 0.36 | 12.5 | 5.0 | 15.2 | 19.2 |
| Example 3 | 0.40 | 11.7 | 5.2 | 14.1 | 20.6 |
| Example 4 | 0.32 | 13.5 | 5.4 | 17.8 | 22.4 |
| Comparative Example 1 | 0.54 | 6.4 | 4.3 | 9.0 | 16.9 |
| Comparative Example 2 | 0.26 | 14.8 | 4.7 | not hardened* | not hardened* |

[Bottom notes in Table 3]
*The specimen was not hardened, and thus the specimen was not separated from the frame, and the strength cannot be measured.
**The admixture addition rate (%) represents the percent by weight of a solid content relative to cement.

As evident from Table 3, the concretes in Examples exhibited a moderate slump, and developed favorable compressive strength at ages of 7 days and 28 days. On the other hand, the concrete in Comparative Example 1 contained an excess of lignin, and thus had a low slump and low compressive strength. In Comparative Example 2, although the addition rate of the chemical admixture was set to be low so as to prevent an excessive slump, the concrete exhibited an excessive slump, and the sample for compressive strength was not hardened. Thus, the compressive strength at ages of 7 days and 28 days cannot be measured. The results show that for preparation of concrete that develops compressive strength, lignin having a predetermined sulfur content needs to be added.

### Examples 5 to 6 and Comparative Examples 3 to 4

### <Blend of Mortar>

Using materials listed in Table 4 at a mortar blend listed in Table 5, a mortar test was performed. In Examples 5 to 6 and Comparative Example 3, KL1 or KL2 was added in each amount shown in Table 5. In Comparative Example 4, VANILLEX N (manufactured by Nippon Paper Industries Co., Ltd., sodium ligninsulfonate, sulfur content: 5.0% by weight, SP50) was added in an amount shown in Table 5 instead of KL1 and KL2. In Example 5 and Comparative Example 3, AD1 was added in an amount described below, and in Example 6 and Comparative Example 4, AD2 was added in an amount described below.

TABLE 4
Materials used

| Type | Mark | Type and production area |
|---|---|---|
| Cement | C | Mixture of equal amounts of 3 types of ordinary |
| | | portalnd cement available from TAIHEIYO |
| | | CEMENT CORPORATION, UBE-MITSUBISHI |
| | | CEMENT CORPORATION, and SUMITOMO |
| | | OSAKA CEMENT, Co., Ltd. Density 3.16 g/cm³ |
| Fine aggregate | S | Mountain sand from Kakegawa Density |
| | | 2.57 g/cm³ |
| Water | W | Tap water from Tsukuba-city |
| Chemical | AD1 | Production Example 3 |
| admixture | AD2 | Production Example 4 |

TABLE 5
Mortar blend

| | W/C | Chemical | Unit amount (kg/m³) | | | | |
|---|---|---|---|---|---|---|---|
| No. | (%) | admixture * | W | C | S | Type of lignin | Lignin content ** |
| Example 5 | 55.0 | AD1 | 215 | 392 | 1258 | KL1 | 120 |
| Example 6 | 55.0 | AD2 | 215 | 392 | 1258 | KL2 | 120 |
| Comparative Example 3 | 55.0 | AD1 | 215 | 392 | 1148 | KL2 | 150 |
| Comparative Example 4 | 55.0 | AD2 | 215 | 392 | 1258 | SP | 120 |

[Bottom notes in Table 5]
* The chemical admixture addition rate (%) represents 0.15% (solid content weight) relative to cement.
** Lignin content: weight (unit: kg) per 1 m³ of concrete

### <Method for Kneading Mortar>

A mortar kneading procedure is as follows. In kneading of mortar, high-power mixer CB-34 manufactured by MARUTO Testing Machine Company was used.

A half amount of sand (fine aggregate), cement, kraft lignin, and a half amount of sand (fine aggregate) were added and then kneaded without water for 10 seconds. Subsequently, water and the chemical admixture were added and then kneaded for 30 seconds at low speed. Next, scraping was performed and then the mixture was kneaded for 90 seconds at high speed, before kneading was stopped.

### <Test Items>

The composition (mortar) obtained after kneading was subjected to the following tests.

### -Slump Test-

A slump test was performed with reference to a method in JIS A1171, and as a mortar flow value, the average value was determined from two diameters after the mortar spread out, Herein, the first diameter was in a direction where the diameter was recognized to be the longest, and the second was in a direction perpendicular to the first direction.

### Compressive Strength Test

In a compressive strength test, a specimen frame having a diameter of 5 cm and a length of 10 cm was filled with the mortar. To obtain the specimen, the mortar was removed after 4 days. The specimen was aged in water, and the compressive strength (20° C.) was measured in accordance with JIS A1108.

The test results are shown in Table 6.

TABLE 6
Test results

| | | Compressive | Compressive |
|---|---|---|---|
| | | strength at age | strength at age |
| | Mortar flow | of 7 days | of 28 days |
| | value (mm) | (N/mm²) | (N/mm²) |
| Example 5 | 100 | 15.5 | 21.9 |
| Example 6 | 100 | 17.5 | 24.0 |
| Comparative Example 3 | 100 | 10.2 | 15.4 |
| Comparative Example 4 | 100 | Not applicable * | Not applicable * |

[Bottom notes in Table 6]
*Four days after kneading, removal of the frame was tried, but the mortar was not cured (was not molded) .

Therefore, the strength measurement at 7 days and 28 days later was not possible.

As evident from Table 6, the mortars in Examples exhibited a moderate mortar flow, and developed favorable compressive strength at ages of 7 days and 28 days. On the other hand, the mortar in Comparative Example 3 had insufficient compressive strength at ages of 7 days and 28 days. Regarding the mortar in Comparative Example 4, the mortar was in an agglomerated state and not cured at 4 days after kneading, and when the frame was removed, the mortar was not molded. Thus, the compressive strength at ages of 7 days and 28 days cannot be measured. As with the concrete test, the results show that for preparation of a mortar that develops compressive strength, lignin having a predetermined sulfur content needs to be added.

1. A cement-based hydraulic material, comprising:
lignin;
a chemical admixture;
cement;
an aggregate; and
water,
wherein the lignin is present in a range of from 10 to 120 kg/m³, and
wherein a sulfur content of the lignin is 2.5 wt. or less, relative to 100 wt. % of the lignin.

2. The material of claim 1, wherein the chemical admixture comprises:
(A) a copolymer comprising, in polymerized form, at least two of a first monomer of formula (1), a second monomer of formula (2), and a third monomer of formula (3): 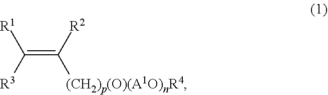
wherein
R¹, R², and R³ each are independently H or an alkyl group of 1 to 3 carbon atoms,
p is 0, 1, or 2,
A¹O is independently an oxyalkylene group of 2 to 18 carbon atoms,
n is an integer in a range of from 40 to 150, and
R⁴ is H or a hydrocarbon group of 1 to 30 carbon atoms; 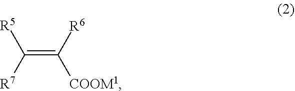
wherein
R⁵, R⁶, and R⁷ are independently H, —CH₃, or —(CH₂)ᵣCOOM²; any of these being —(CH₂)ᵣCOOM², optionally forming an anhydride with —COOM¹ or another —(CH₂)ᵣCOOM², the anhydride lacking M¹ and M², M¹ and M², independently being H, an alkali metal, an alkaline earth metal, an ammonium group, an alkylammonium group, or a substituted alkylammonium group, and
r is 0, 1, or 2; 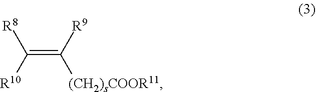
wherein
R⁸, R⁹, and R¹⁰ are independently H or an alkyl group of 1 to 3 carbon atoms,
R¹¹ is a hydrocarbon group of 1 to 4 carbon atoms optionally comprising a heteroatom; and
s is 0, 1, or 2.

3. Concrete, prepared from the material of claim 1.

4. Mortar, prepared from the material of claim 1.

5. The material of claim 1, wherein the lignin is present in a range of from 10 to 110 kg/m³.

6. The material of claim 1, wherein the lignin is present in a range of from 30 to 120 kg/m³.

7. The material of claim 1, wherein the lignin is present in a range of from 30 to 110 kg/m³.

8. The material of claim 1, wherein the sulfur content of the lignin is in a range of from more than 0 to 2.5 wt. % or less, relative to 100 wt. % of the lignin.

9. The material of claim 1, wherein the sulfur content of the lignin is in a range of from more than 1.5 to 2.5 wt. % or less, relative to 100 wt. % of the lignin.

10. The material of claim 1, wherein the sulfur content of the lignin is in a range of from more than 1.6 to 2.5 wt. % or less, relative to 100 wt. % of the lignin.

11. The material of claim 1, wherein the sulfur content of the lignin is in a range of from more than 1.6 to 2.1 wt. % or less, relative to 100 wt. % of the lignin.

12. The material of claim 1, wherein the cement is an amount corresponding to a range of from 100 to 500 kg/m³.

13. The material of claim 1, wherein the cement is an amount corresponding to a range of from 150 to 500 kg/m³.

14. The material of claim 1, wherein the cement is an amount corresponding to a range of from 200 to 500 kg/m³.

15. The material of claim 1, wherein a content of the chemical admixture relative to the cement is in a range of from 0.1 to 0.8 wt. %.

16. The material of claim 2, wherein a content of the chemical admixture relative to the cement is in a range of from 0.01 to 0.7 wt. %.

17. The material of claim 2, wherein a content of the chemical admixture relative to the cement is in a range of from 0.05 to 0.5 wt. %.

18. The material of claim 2, wherein the copolymer (A) has a weight-average molecular weight in a range of from 5,000 to 60,000.
